(19) United States
(12) Patent Application Publication
(10) Pub. No.: US 2026/0179906 A1
(43) Pub. Date: Jun. 25, 2026

(54) METHOD OF PRODUCING LITHIUM ION SECONDARY BATTERY

(71) Applicant: ADEKA CORPORATION, Tokyo (JP)

(72) Inventors: Kenji KAKIAGE, Tokyo (JP); Toru YANO, Tokyo (JP)

(73) Assignee: ADEKA CORPORATION, Tokyo (JP)

(21) Appl. No.: 19/125,466

(22) PCT Filed: Oct. 25, 2023
(86) PCT No.: PCT/JP2023/038474

§ 371 Date: Apr. 29, 2025

(30) Foreign Application Priority Data
Nov. 2, 2022 (JP) 2022-176500

(51) Int. Cl. H01M 4/04; H01M 4/60; H01M 10/0525; H01M 50/609

(52) U.S. Cl. CPC H01M 4/0447; H01M 4/604; H01M 10/0525; H01M 50/609

(57) ABSTRACT

Provided is a method of producing a lithium ion secondary battery, the method including: a charge and discharge treatment step of subjecting a first lithium ion secondary battery including a positive electrode having a positive electrode active material layer containing a sulfur-modified compound, a first liquid electrolyte, and a negative electrode to charge and discharge treatment; and a replacement step of replacing the first liquid electrolyte with a second liquid electrolyte to provide a second lithium ion secondary battery after the charge and discharge treatment step, wherein the first liquid electrolyte contains a solvent selected from the group consisting of: a saturated cyclic carbonate compound; and a saturated chain carbonate compound, and wherein the second liquid electrolyte contains a solvent selected from the group consisting of: a saturated cyclic ether compound; and a saturated chain ether compound.

### TECHNICAL FIELD

This disclosure relates to a method of producing a lithium ion secondary battery.

### BACKGROUND ART

A lithium ion secondary battery is used for various applications. The characteristics of the lithium ion secondary battery depend on an electrode, a separator, an electrolyte, and the like serving as constituent members of the battery, and research and development have been actively made on the respective constituent members. In the positive electrode, an active material in a positive electrode active material layer is important as well as a binder, a conductive assistant, a current collector material, and the like, and research and development have been actively made on the active material. For example, a sulfur-modified polyacrylonitrile-based compound is known as the active material (see, for example, Patent Documents 1 and 2).

### CITATION LIST

### Patent Document

Patent Document 1: JP 2010-153296 A
Patent Document 2: JP 2012-099342 A

### Non Patent Document

Non Patent Document 1: Energies 2014, 7, 4588-4600

### SUMMARY OF INVENTION

### Technical Problem

An active material capable of forming a lithium ion secondary battery having an increased discharge capacity and an excellent cycle characteristic is required. Further, lithium ion secondary batteries for general applications, such as an electronic apparatus and a transportation apparatus, need to be light-weight. The lithium ion secondary battery of each of Patent Documents 1 and 2 uses a mixed solvent of ethylene carbonate and diethyl carbonate as a liquid electrolyte, and hence may cause a problem in that the liquid electrolyte having a high density increases the mass of the battery.

This disclosure has been made in view of the above-mentioned problems, and a primary object thereof is to provide a method of producing a lithium ion secondary battery having an increased discharge capacity, an excellent cycle characteristic, and a light weight.

In this disclosure, the term “cycle characteristic” refers to a characteristic in which the charge and discharge capacity of a lithium ion secondary battery is maintained even while charge and discharge are repeatedly performed. Accordingly, a lithium ion secondary battery having a large degree of reduction in charge and discharge capacity and a low capacity retention rate, as a result of repeated charge and discharge, is poor in cycle characteristic. In contrast, a lithium ion secondary battery having a small degree of reduction in charge and discharge capacity and a high capacity retention rate is excellent in cycle characteristic.

### Solution to Problem

The inventors of the present invention have made extensive investigations, and as a result, have found that the above-mentioned problem can be solved by a method of producing a lithium ion secondary battery that satisfies predetermined conditions.

That is, according to this disclosure, there is provided a method of producing a lithium ion secondary battery, the method including: a charge and discharge treatment step of subjecting a first lithium ion secondary battery including a positive electrode having a positive electrode active material layer containing a sulfur-modified compound, a first liquid electrolyte, and a negative electrode to charge and discharge treatment; and a replacement step of replacing the first liquid electrolyte with a second liquid electrolyte to provide a second lithium ion secondary battery after the charge and discharge treatment step, wherein the first liquid electrolyte contains a solvent selected from the group consisting of: a saturated cyclic carbonate compound; and a saturated chain carbonate compound, and wherein the second liquid electrolyte contains a solvent selected from the group consisting of: a saturated cyclic ether compound; and a saturated chain ether compound.

In this disclosure, it is preferred that the sulfur-modified compound be a sulfur-modified acrylic compound.

In this disclosure, it is preferred that the sulfur-modified acrylic compound be a sulfur-modified polyacrylonitrile-based compound.

In this disclosure, it is preferred that a sulfur content of the sulfur-modified compound fall within a range of from 10 mass % to 80 mass %.

In this disclosure, it is preferred that a density at 25° C. of the first liquid electrolyte fall within a range of from 1.21 g/cm³ to 1.60 g/cm³, and a density at 25° C. of the second liquid electrolyte fall within a range of from 0.80 g/cm³ to 1.20 g/cm³.

In this disclosure, it is preferred that the charge and discharge treatment step include performing discharge under conditions where a discharge end potential of the positive electrode is from 0.3 V(Li⁺/Li) to 1.8 V(Li⁺/Li), and performing charge under conditions where a charge end potential of the positive electrode is from 2.0 V(Li⁺/Li) to 4.3 V(Li⁺/Li).

### Advantageous Effects of Invention

According to this disclosure, the method of producing a lithium ion secondary battery having an increased discharge capacity, an excellent cycle characteristic, and a light weight can be provided.

### DESCRIPTION OF EMBODIMENTS

A method of producing a lithium ion secondary battery of this disclosure is described in detail.

A. Method of producing Lithium Ion Secondary Battery

A method of producing a lithium ion secondary battery of this disclosure is a method of producing a lithium ion secondary battery, the method including: a charge and discharge treatment step of subjecting a first lithium ion secondary battery including a positive electrode having a positive electrode active material layer containing a sulfur-modified compound, a first liquid electrolyte, and a negative electrode to charge and discharge treatment; and a replacement step of replacing the first liquid electrolyte with a second liquid electrolyte to provide a second lithium ion secondary battery after the charge and discharge treatment step, wherein the first liquid electrolyte contains a solvent selected from the group consisting of: a saturated cyclic carbonate compound; and a saturated chain carbonate compound, and wherein the second liquid electrolyte contains a solvent selected from the group consisting of: a saturated cyclic ether compound; and a saturated chain ether compound.

In general, in a lithium ion secondary battery using a liquid electrolyte, the mass of the liquid electrolyte accounts for 20% or more of the mass of the lithium ion secondary battery. An example of a procedure of reducing the weight of the lithium ion secondary battery is the use of a liquid electrolyte having a low density. An example of the liquid electrolyte having a low density is a liquid electrolyte containing a solvent selected from the group consisting of: a saturated cyclic ether compound; and a saturated chain ether compound. However, as described in Non Patent Document 1, it has been known that a lithium ion secondary battery that contains a sulfur-modified compound as a positive electrode active material, and uses a liquid electrolyte containing a solvent selected from the group consisting of: a saturated cyclic ether compound; and a saturated chain ether compound has a reduced cycle characteristic.

The method of producing a lithium ion secondary battery of this disclosure can solve such problem and provide a lithium ion secondary battery having an increased discharge capacity, an excellent cycle characteristic, and a light weight.

The reason why such effects are exhibited is assumed to be as described below. It is assumed that when a lithium ion secondary battery that includes a positive electrode containing a sulfur-modified compound as a positive electrode active material and uses a liquid electrolyte containing a solvent selected from the group consisting of: a saturated cyclic carbonate compound; and a saturated chain carbonate compound is first charged and discharged, a coating film adapted to a liquid electrolyte containing a solvent selected from the group consisting of: a saturated cyclic ether compound; and a saturated chain ether compound is formed on a surface of the sulfur-modified compound. It is assumed that even when a lithium ion secondary battery using a liquid electrolyte containing a solvent selected from the group consisting of: a saturated cyclic ether compound; and a saturated chain ether compound is then produced and charged and discharged through use of a positive electrode containing the sulfur-modified compound having the coating film formed on its surface as the positive electrode active material, a cycle characteristic is not reduced like the known art.

The method of producing a lithium ion secondary battery of this disclosure may also be used as a method of recycling a lithium ion secondary battery.

### 1. Charge and Discharge Treatment Step

The charge and discharge treatment step in this disclosure is a step of subjecting a first lithium ion secondary battery to charge and discharge treatment.

### (1) First Lithium Ion Secondary Battery

The first lithium ion secondary battery used in the above-mentioned step has only to include: a positive electrode having a positive electrode active material layer containing a sulfur-modified compound; a first liquid electrolyte; and a negative electrode.

The first lithium ion secondary battery is different from a second lithium ion secondary battery obtained by the production method of this disclosure.

### (1-1) Positive Electrode

The term “positive electrode” in this disclosure refers to a positive electrode having a positive electrode active material layer containing a sulfur-modified compound. In this disclosure, the term “positive electrode active material layer” refers to an electrode layer of a positive electrode. In this disclosure, the sulfur-modified compound effectively functions as a positive electrode active material.

### (1-1-1) Sulfur-modified Compound

In this disclosure, the same sulfur-modified compound as that described in the section “(2) Sulfur-modified Compound” in “A. Method of producing Lithium Ion Secondary Battery” to be described later may be used as the sulfur-modified compound contained in the positive electrode active material layer, and hence description thereof is omitted in this section.

The content of the sulfur-modified compound is preferably from 75 parts by mass to 99.5 parts by mass, more preferably from 80 parts by mass to 99 parts by mass, still more preferably from 85 parts by mass to 98 parts by mass with respect to 100 parts by mass of the positive electrode active material layer from the viewpoint that the discharge capacity is increased.

### (1-1-2) Other Component

In this disclosure, the positive electrode active material layer contains the sulfur-modified compound, but may contain any other component as required.

In this disclosure, examples of the other component contained in the positive electrode active material layer include a binder, a conductive assistant, an active material other than the sulfur-modified compound, a viscosity modifier, a reinforcing material, and an antioxidant.

A binder known as a binder for a positive electrode active material layer may be used as the binder. Examples of the binder include a styrene-butadiene rubber, a butadiene rubber, polyethylene, polypropylene, polyamide, polyamide imide, polyimide, polyacrylonitrile, polyurethane, polyvinylidene fluoride, polytetrafluoroethylene, an ethylene-propylene-diene rubber, a fluororubber, a styrene-acrylic acid ester copolymer, an ethylene-vinyl alcohol copolymer, an acrylonitrile butadiene rubber, a styrene-isoprene rubber, polymethyl methacrylate, polyacrylate, polyvinyl alcohol, polyvinyl ether, carboxymethyl cellulose, sodium carboxymethyl cellulose, methyl cellulose, a cellulose nanofiber, polyethylene oxide, starch, polyvinylpyrrolidone, polyvinyl chloride, and polyacrylic acid. The binders may be used alone or in combination thereof. Of those, an aqueous binder is preferred, and a styrene-butadiene rubber, sodium carboxymethyl cellulose, and polyacrylic acid are each more preferred from the viewpoints of its low environmental load and excellent binding property.

The content of the binder in the positive electrode active material layer is preferably from 1 part by mass to 30 parts by mass, more preferably from 1 part by mass to 20 parts by mass with respect to 100 parts by mass of the sulfur-modified compound in the positive electrode active material layer from the viewpoint that the discharge capacity is further increased.

A conductive assistant known as a conductive assistant for a positive electrode active material layer may be used as the conductive assistant. Examples of the conductive assistant include: carbon materials, such as natural graphite, artificial graphite, carbon black, ketjen black, acetylene black, channel black, furnace black, lamp black, thermal black, a carbon nanotube, a vapor grown carbon fiber (VGCF), graphene, fullerene, and needle coke; metal powders, such as aluminum powder, nickel powder, and titanium powder; conductive metal oxides, such as zinc oxide and titanium oxide; and sulfides, such as La₂S₃, Sm₂S₃, Ce₂S₃, and TiS₂. The conductive assistants may be used alone or in combination thereof.

The average particle diameter of the conductive assistant to be used in the positive electrode active material layer is preferably from 0.0001 μm to 100 μm, more preferably from 0.01 μm to 50 μm from the viewpoint that the discharge capacity is increased. In this disclosure, the “average particle diameter” refers to a 50% particle diameter measured by a laser diffraction light scattering method. In the laser diffraction light scattering method, the particle diameter is a diameter on a volume basis, and a secondary particle diameter of a measurement object is measured. When the average particle diameter is measured by the laser diffraction light scattering method, the measurement object is dispersed in a dispersing medium such as water and then subjected to the measurement.

The content of the conductive assistant in the positive electrode active material layer is preferably from 0.05 part by mass to 20 parts by mass, more preferably from 0.1 part by mass to 10 parts by mass, still more preferably from 0.5 part by mass to 8.0 parts by mass with respect to 100 parts by mass of the sulfur-modified compound in the positive electrode active material layer from the viewpoint that the discharge capacity is further increased.

Examples of the above-mentioned active material other than the sulfur-modified compound (hereinafter sometimes referred to as “other active material”) include materials known as active materials, such as a lithium transition metal composite oxide, a lithium-containing transition metal phosphoric acid compound, and a lithium-containing silicate compound.

A viscosity modifier known as a viscosity modifier for a positive electrode active material layer may be used as the viscosity modifier. Examples of the viscosity modifier include: a cellulose-based polymer, such as carboxymethyl cellulose, methyl cellulose, or hydroxypropyl cellulose, and an ammonium salt and alkali metal salt thereof; (modified) poly(meth)acrylic acid, and an ammonium salt and alkali metal salt thereof; polyvinyl alcohols, such as (modified) polyvinyl alcohol, a copolymer of acrylic acid or an acrylic acid salt and vinyl alcohol, and a copolymer of maleic anhydride or maleic acid or fumaric acid and vinyl alcohol; polyethylene glycol; polyethylene oxide; polyvinylpyrrolidone; modified polyacrylic acid; oxidized starch; phosphorylated starch; casein; various modified starches; and a hydrogenated acrylonitrile-butadiene copolymer.

A reinforcing material known as a reinforcing material for a positive electrode active material layer may be used as the reinforcing material. Examples of the reinforcing material include various inorganic and organic fillers each having a spherical, plate-like, rod-like, or fibrous shape.

An antioxidant known as an antioxidant for a positive electrode active material layer may be used as the antioxidant. Examples of the antioxidant include a phenol compound, a hydroquinone compound, an organic phosphorus compound, a sulfur compound, a phenylenediamine compound, and a polymer-type phenol compound.

### (1-1-3) Thickness of Positive Electrode Active Material Layer and Method of Forming Positive Electrode Active Material Layer

The thickness of the positive electrode active material layer may be generally from 1 μm to 1,000 μm.

A known method capable of forming a positive electrode active material layer has only to be adopted as a method of forming the positive electrode active material layer, and is, for example, a method including: applying a composition for forming a positive electrode active material layer containing the sulfur-modified compound, the other component incorporated as required, and a solvent to a current collector to be described later to form a coating film; and then removing the solvent from the coating film by drying.

Examples of the solvent include propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolane, nitromethane, N-methylpyrrolidone, N,N-dimethylformamide, dimethylacetamide, methyl ethyl ketone, cyclohexanone, methyl acetate, methyl acrylate, diethyltriamine, N,N-dimethylaminopropylamine, polyethylene oxide, tetrahydrofuran, dimethyl sulfoxide, sulfolane, γ-butyrolactone, water, and an alcohol. The usage amount of the solvent may be adjusted in accordance with an application method. For example, in the case of a doctor blade method, the usage amount of the solvent is preferably from 20 parts by mass to 300 parts by mass, more preferably from 30 parts by mass to 200 parts by mass with respect to 100 parts by mass of the total amount of the sulfur-modified compound, the binder, and the conductive assistant from the viewpoint that the production is easy.

A method of preparing the composition for forming a positive electrode active material layer is not particularly limited, but may be, for example, a method including using an ordinary ball mill, a sand mill, a bead mill, a pigment disperser, a mortar machine, an ultrasonic disperser, a homogenizer, a rotation/revolution mixer, a planetary mixer, FILMIX, DESPA, or JETPASTER.

The application method is not particularly limited, and various methods, such as a die coater method, a comma coater method, a curtain coater method, a spray coater method, a gravure coater method, a flexo coater method, a knife coater method, a doctor blade method, a reverse roll method, a brush coating method, and a dip method, may each be used. Of those, a die coater method, a doctor blade method, a knife coater method, and a comma coater method are preferred from the viewpoint that a satisfactory surface state of the coating film can be achieved in accordance with the physical properties such as viscosity of the composition for forming a positive electrode active material layer and the drying property thereof.

A drying removal method is not particularly limited, and heating, decompression, and a method including a combination thereof may each be used. A heating temperature may be from 40° C. to 200° C. A heating furnace, an infrared heating furnace, a vacuum oven, or the like may be used as an apparatus for the heating or the decompression. The drying volatilizes a volatile component such as the solvent to form the positive electrode active material layer. After that, the positive electrode active material layer may be subjected to press processing as required. As a method for the press processing, there are given, for example, a mold press method and a roll press method.

### (1-1-4) Other Configuration

In this disclosure, the positive electrode has the positive electrode active material layer, and may have any other configuration as required. Such other configuration is, for example, a current collector.

A conductive material, such as titanium, a titanium alloy, aluminum, an aluminum alloy, copper, nickel, stainless steel, nickel-plated steel, or a conductive resin, is used as a material for forming the current collector. The surfaces of those conductive materials may each be coated with carbon. The current collector has a foil shape, a sheet shape, a mesh shape, a porous shape, or the like. Of those options, aluminum is preferred, and aluminum foil is more preferred from the viewpoints of conductivity and cost. When the current collector has a foil shape, its thickness is preferably from 1 μm to 1,000 μm from the viewpoint that the discharge capacity is further increased and the production is easy.

The positive electrode may be subjected to press processing as required. As a method for the press processing, there are given, for example, a mold press method and a roll press method.

The positive electrode may be subjected to predoping treatment including inserting lithium in advance. A lithium predoping method has only to follow a known method, and examples thereof include: an electrolysis doping method in which a half cell is assembled by using metal lithium as a counter electrode, and the electrode is electrochemically doped with lithium; and a diffusion doping method in which metal lithium foil is bonded to an electrode, and then the electrode is left in a liquid electrolyte and doped with lithium through utilization of diffusion of lithium into the electrode.

In this disclosure, the surface of the positive electrode may be coated with a coating material. Examples of the coating material include polymer coating materials such as polyvinylidene fluoride, and inorganic coating materials, such as alumina and silica.

### (1-2) Negative Electrode

The negative electrode in this disclosure has a negative electrode active material layer.

### (1-2-1) Negative Electrode Active Material Layer

In this disclosure, the term “negative electrode active material layer” refers to an electrode layer of a negative electrode. The negative electrode active material layer has only to contain a known negative electrode active material.

Examples of the negative electrode active material include natural graphite, artificial graphite, non-graphitizable carbon, graphitizable carbon, lithium, a lithium alloy, silicon, a silicon alloy, silicon oxide, tin, a tin alloy, tin oxide, phosphorus, germanium, indium, copper oxide, antimony sulfide, titanium oxide, iron oxide, manganese oxide, cobalt oxide, nickel oxide, lead oxide, ruthenium oxide, tungsten oxide, and zinc oxide, and as well, composite oxides, such as LiVO₂, Li₂VO₄, and Li₄Ti₅O₁₂. The negative electrode active materials may be used alone or in combination thereof. In this disclosure, the negative electrode active material is preferably silicon, a silicon alloy, silicon oxide, lithium, or a lithium alloy, more preferably lithium from the viewpoint that the discharge capacity is further increased.

The negative electrode active material layer contains the negative electrode active material, and may contain, for example, a binder or a conductive assistant as required.

The same binder and conductive assistant as those described in the above-mentioned section “(1-1-2) Other Component” of “(1) First Lithium Ion Secondary Battery” of “1. Charge and Discharge Treatment Step” in “A. Method of producing Lithium Ion Secondary Battery” may be used as the binder and the conductive assistant used in the negative electrode active material layer, and hence description thereof is omitted in this section.

### (1-2-2) Other Configuration

The negative electrode in this disclosure has the above-mentioned negative electrode active material layer, but may contain any other configuration as required. An example of the other configuration is a current collector. The same current collector as that described in the section “(1-1-4) Other Configuration” of “(1) First Lithium Ion Secondary Battery” of “1. Charge and Discharge Treatment Step” in “A. Method of producing Lithium Ion Secondary Battery” may be used as the current collector, and hence description thereof is omitted in this section.

In this disclosure, the surface of the negative electrode may be coated with a coating material. Examples of the coating material include polymer coating materials such as polyvinylidene fluoride, and inorganic coating materials, such as alumina and silica.

### (1-3) First Liquid Electrolyte

A liquid electrolyte obtained by dissolving a supporting electrolyte in a solvent selected from the group consisting of: a saturated cyclic carbonate compound; and a saturated chain carbonate compound may be used as the first liquid electrolyte.

In this disclosure, the density at 25° C. of the first liquid electrolyte preferably falls within the range of from 1.21 g/cm³ to 1.60 g/cm³, more preferably falls within the range of from 1.21 g/cm³ to 1.40 g/cm³, still more preferably falls within the range of from 1.22 g/cm³ to 1.38 g/cm³, and most preferably falls within the range of from 1.25 g/cm³ to 1.35 g/cm³ from the viewpoint that the discharge capacity is increased and an excellent cycle characteristic is exhibited.

The density at 25° C. was measured with a 5 ml Gay-Lussac type pycnometer under the condition of 25° C. in conformity with JIS Z 8804:2012 “6. Methods of measuring density and specific gravity with pycnometer.”

Examples of the supporting electrolyte to be used for the first liquid electrolyte include LiPF₆, LiBF₄, LiAsF₆, LiCF₃SO₃, LiCF₃CO₂, LiN(CF₃SO₂)₂, LiN(C₂F₅SO₂)₂, LiN(SO₂F)₂, LiC(CF₃SO₂)₃, LiB(CF₃SO₃)₄, LiB(C₂O₄)₂, LiBF₂(C₂O₄), LiNO₃, LiSbF₆, LiSiF₅, LiSCN, LiClO₄, LiCl, LiF, LiBr, LiI, LiAlF₄, LiAlCl₄, LiPO₂F₂, lithium 1,1,2,2,3,3-hexafluoropropane-1,3-disulfonimide, and derivatives thereof. Of those, one or more kinds selected from the group consisting of: LiPF₆; LiBF₄; LiClO₄; LiAsF₆; LiCF₃SO₃; LiN(CF₃SO₂)₂; LiN(C₂F₅SO₂)₂; LiN(SO₂F)₂; LiNO₃; lithium 1,1,2,2,3,3-hexafluoropropane-1,3-disulfonimide; LiC(CF₃SO₂)₃; derivatives of LiCF₃SO₃; and derivatives of LiC(CF₃SO₂) s are preferably used from the viewpoint that the discharge capacity is further increased.

The content of the supporting electrolyte in the first liquid electrolyte is preferably from 0.5 mol/L to 7 mol/L, more preferably from 0.8 mol/L to 1.8 mol/L from the viewpoint that the discharge capacity is further increased.

The solvent used for the first liquid electrolyte has only to contain one or more kinds selected from the group consisting of: a saturated cyclic carbonate compound; and a saturated chain carbonate compound. The solvent may be used in combination with any other solvent, such as acetonitrile, propionitrile, nitromethane, a derivative thereof, or various ionic liquids, as long as the other solvent does not adversely affect the lithium ion secondary battery of this disclosure.

The content of a compound selected from the group consisting of: a saturated cyclic carbonate compound; and a saturated chain carbonate compound in the solvent of the first liquid electrolyte is preferably 60 vol % or more, more preferably 80 vol % or more, still more preferably 85 vol % or more, still more preferably 90 vol % or more, still more preferably 95 vol % or more, most preferably 98 vol % or more from the viewpoint that the discharge capacity is increased and an excellent cycle characteristic is exhibited.

In this disclosure, the term “vol %” refers to a volume ratio measured under an environment of 25° C.

Examples of the saturated cyclic carbonate compound include ethylene carbonate, vinylene carbonate, fluoroethylene carbonate, 1,2-propylene carbonate, 1,3-propylene carbonate, 1,2-butylene carbonate, 1,3-butylene carbonate, and 1,1-dimethylethylene carbonate. Those solvents may be used alone or in combination thereof.

Examples of the saturated chain carbonate compound include dimethyl carbonate, ethyl methyl carbonate, diethyl carbonate, ethyl butyl carbonate, methyl-t-butyl carbonate, diisopropyl carbonate, and t-butyl propyl carbonate. Those solvents may be used alone or in combination thereof.

In this disclosure, among the above-mentioned saturated cyclic carbonate compounds and saturated chain carbonate compounds, one or more kinds selected from the group consisting of: ethylene carbonate; vinylene carbonate; fluoroethylene carbonate; 1,2-propylene carbonate; dimethyl carbonate; ethyl methyl carbonate; and diethyl carbonate are preferably used, and one or more kinds selected from the group consisting of: ethylene carbonate; fluoroethylene carbonate; and diethyl carbonate are more preferably used from the viewpoint that a lithium ion secondary battery having an increased discharge capacity, an excellent cycle characteristic, and a light weight can be formed.

For example, to prolong the lifetime of the lithium ion secondary battery and improve the safety thereof, the first liquid electrolyte may contain any other known additive, such as an electrode film forming agent, an antioxidant, a flame retardant, or an overcharge inhibitor. The content of the other additive is generally from 0.01 part by mass to 10 parts by mass, preferably from 0.1 part by mass to 5 parts by mass with respect to 100 parts by mass of the first liquid electrolyte from the viewpoint that the discharge capacity is further increased.

### (1-4) Other Configuration

Another configuration of the first lithium ion secondary battery is, for example, a separator. The separator is not particularly limited as long as lithium ions are allowed to permeate therethrough and the contact between the positive electrode and the negative electrode can be prevented, but for example, a microporous polymer film or a non-woven fabric may be used. Examples of the film include films formed of polymer compounds containing, as main components, for example, any of polyethylene, polypropylene, polyvinylidene fluoride, polyvinylidene chloride, polyacrylonitrile, polyacrylamide, polytetrafluoroethylene, polysulfone, polyethersulfone, polycarbonate, polyamide, polyimide, polyethers, such as polyethylene oxide and polypropylene oxide, various celluloses, such as carboxymethyl cellulose and hydroxypropyl cellulose, and poly(meth)acrylic acid and various esters thereof, derivatives thereof, and copolymers and mixtures thereof. Those films may each be coated with a ceramic material, such as alumina or silica, magnesium oxide, an aramid resin, or polyvinylidene fluoride.

Those films may be used alone or as a multi-layer film in which the films are laminated on each other. Further, various additives may be contained in those films, and the kinds and contents thereof are not particularly limited. Of those films, a film formed of polyethylene, polypropylene, polyvinylidene fluoride, or polysulfone is preferred from the viewpoint that the discharge capacity of the lithium ion secondary battery is further increased.

### (2) Sulfur-Modified Compound

### (2-1) Material

For example, a compound having a covalent bond or the like formed from a sulfur atom and an atom derived from an organic compound may be used as the sulfur-modified compound contained in the positive electrode active material layer. As a method of producing such sulfur-modified compound, there is given, for example, a method including heating elemental sulfur and the organic compound.

In the above-mentioned sulfur-modified compound, the sulfur for forming a covalent bond or the like with an atom derived from the organic compound may be formed of one sulfur atom, or may be a plurality of sulfur atoms, such as a disulfide or a trisulfide. When a plurality of sulfur atoms are present, part of the sulfur atoms have only to interact with each other, and for example, when the plurality of sulfur atoms are linear sulfur, the sulfur atom on at least one end may form a stable interaction. The stable interaction is, for example, a covalent bond or an ionic bond.

Examples of the organic compound include an acrylic compound, a polyether compound, a pitch compound, a polynuclear aromatic compound, an aliphatic hydrocarbon compound, and a thienoacene compound.

That is, examples of the sulfur-modified compound include a sulfur-modified acrylic compound, a sulfur-modified polyether compound, a sulfur-modified pitch compound, a sulfur-modified polynuclear aromatic compound, a sulfur-modified aliphatic hydrocarbon compound, a polythienoacene compound, and carbon polysulfide.

In this disclosure, the sulfur-modified compound is preferably selected from the group consisting of: a sulfur-modified acrylic compound; a sulfur-modified polynuclear aromatic compound; and a sulfur-modified polyether compound, and is more preferably a sulfur-modified acrylic compound from the viewpoint that the discharge capacity is further increased.

The sulfur content of the sulfur-modified compound is not particularly limited, but preferably falls within the range of from 10 mass % to 80 mass %, more preferably falls within the range of from 20 mass % to 80 mass %, still more preferably falls within the range of from 30% mass % to 80 mass %, still more preferably falls within the range of from 35 mass % to 75 mass %, still more preferably falls within the range of from 40 mass % to 75 mass %, still more preferably falls within the range of from 45 mass % to 70 mass %, still more preferably falls within the range of from 45 mass % to 65 mass %, and most preferably falls within the range of from 45 mass % to 60 mass % from the viewpoint that the discharge capacity is further increased.

Herein, the term “sulfur content” may refer to the total content of sulfur atoms with respect to the total mass of the sulfur-modified compound. The sulfur content of the sulfur-modified compound may be calculated from the results of analysis with a CHNS analyzer capable of analyzing sulfur and oxygen.

### (2-1-1) Sulfur-modified Acrylic Compound

For example, a compound having a covalent bond or the like formed from a sulfur atom and an atom in an acrylic compound may be used as the sulfur-modified acrylic compound. As a method of producing such sulfur-modified acrylic compound, there is given, for example, a method including heating elemental sulfur and the acrylic compound.

In this disclosure, examples of the sulfur-modified acrylic compound include a sulfur-modified polyacrylonitrile-based compound and other sulfur-modified acrylic compounds. The sulfur-modified acrylic compound is preferably a sulfur-modified polyacrylonitrile-based compound from the viewpoint that the discharge capacity is increased.

The sulfur content when the sulfur-modified compound is a sulfur-modified acrylic compound is not particularly limited, but preferably falls within the range of from 10 mass % to 80 mass %, more preferably falls within the range of from 20 mass % to 80 mass %, still more preferably falls within the range of from 30 mass % to 80 mass %, still more preferably falls within the range of from 35 mass % to 75 mass %, still more preferably falls within the range of from 40 mass % to 75 mass %, still more preferably falls within the range of from 45 mass % to 70 mass %, still more preferably falls within the range of from 45 mass % to 65 mass %, and most preferably falls within the range of from 45 mass % to 60 mass % from the viewpoint that the discharge capacity is further increased.

### (2-1-1-1) Sulfur-modified Polyacrylonitrile-based Compound

For example, a compound in which a sulfur atom and an atom in a polyacrylonitrile-based compound are covalently bonded to each other may be used as the sulfur-modified polyacrylonitrile-based compound in this disclosure. As a method of producing such sulfur-modified polyacrylonitrile-based compound, there is given, for example, a method including heating elemental sulfur and the polyacrylonitrile-based compound. In addition, the sulfur-modified polyacrylonitrile-based compound in this disclosure may contain a compound obtained by a method including heating particles obtained by incorporating a hydrocarbon into an outer shell formed of the polyacrylonitrile-based compound, and the elemental sulfur. The hydrocarbon to be incorporated may be a saturated or unsaturated aliphatic hydrocarbon having 3 to 8 carbon atoms.

In this disclosure, the polyacrylonitrile-based compound has only to be a compound containing a constituent unit derived from at least one of acrylonitrile or methacrylonitrile. The polyacrylonitrile-based compound preferably contains at least the constituent unit derived from acrylonitrile from the viewpoint that the discharge capacity is increased.

The content of the constituent units derived from acrylonitrile and methacrylonitrile in 100 parts by mass of the polyacrylonitrile-based compound is preferably 10 parts by mass or more, more preferably 30 parts by mass or more from the viewpoint that the discharge capacity is increased.

When the polyacrylonitrile-based compound contains the constituent unit derived from acrylonitrile, from the viewpoint that the discharge capacity is increased, the content of the constituent unit derived from acrylonitrile in 100 parts by mass of the polyacrylonitrile-based compound is preferably 10 parts by mass or more, more preferably 30 parts by mass or more, still more preferably 50 parts by mass or more, still more preferably 80 parts by mass or more, still more preferably 85 parts by mass or more, still more preferably 90 parts by mass or more, still more preferably 95 parts by mass or more, most preferably 100 parts by mass, that is, it is most preferred that the polyacrylonitrile-based compound be formed only of the constituent unit derived from acrylonitrile.

When the polyacrylonitrile-based compound contains the constituent unit derived from methacrylonitrile, from the viewpoint that the discharge capacity is increased, the content of the constituent unit derived from methacrylonitrile in 100 parts by mass of the polyacrylonitrile-based compound is preferably 10 parts by mass or more, more preferably 30 parts by mass or more, still more preferably from 30 parts by mass to 95 parts by mass, still more preferably 30 parts by mass to 90 parts by mass, still more preferably 30 parts by mass to 85 parts by mass, most preferably 30 parts by mass to 80 parts by mass.

The polyacrylonitrile-based compound may contain a constituent unit derived from another monomer excluding acrylonitrile and methacrylonitrile. Examples of the other monomer include: acrylic monomers, such as a (meth)acrylate, a (meth)acrylic acid ester, (meth)acrylamide, ethylene glycol (meth)acrylate, 1,6-hexanediol (meth)acrylate, neopentyl glycol di(meth)acrylate, and glycerin di(meth)acrylate; and conjugated dienes, such as butadiene and isoprene. Those other monomers may be used in combination thereof.

Herein, the term “(meth)acrylate” refers to any one of “acrylate” and “methacrylate”. The term “(meth)acryl” refers to any one of “acryl” and “methacryl”.

The Raman spectrum of the sulfur-modified polyacrylonitrile-based compound in this disclosure has only to be a Raman spectrum in which the lithium ion secondary battery of this disclosure can exhibit desired effects, but the Raman spectrum is preferably a Raman spectrum in which a peak is present within the range of a Raman shift of 1,327 cm⁻¹±10 cm⁻¹ from the viewpoint that the discharge capacity is increased. From the viewpoint that the discharge capacity is increased, in addition to the peak within the range of 1,327 cm⁻¹±10 cm⁻¹ described above, the Raman spectrum of the sulfur-modified polyacrylonitrile-based compound preferably has a peak within at least one range selected from the range of 1,531 cm⁻¹±10 cm⁻¹, the range of 939 cm⁻¹±10 cm⁻¹, the range of 479 cm⁻¹±10 cm⁻¹, the range of 377 cm⁻¹±10 cm⁻¹, and the range of 318 cm⁻¹±10 cm⁻¹, more preferably has peaks within at least two ranges selected from the range of 1,531 cm⁻¹±10 cm⁻¹, the range of 939 cm⁻¹±10 cm⁻¹, the range of 479 cm⁻¹±10 cm⁻¹, the range of 377 cm⁻¹±10 cm⁻¹, and the range of 318 cm⁻¹±10 cm⁻¹, and still more preferably has peaks within all of the range of 1,531 cm⁻¹±10 cm⁻¹, the range of 939 cm⁻¹±10 cm⁻¹, the range of 479 cm⁻¹±10 cm⁻¹, the range of 377 cm⁻¹±10 cm⁻¹, and the range of 318 cm⁻¹±10 cm⁻¹.

From the viewpoint that the discharge capacity is increased, in the Raman spectrum of the sulfur-modified polyacrylonitrile-based compound, a ratio (A1/B1) of a peak intensity A1 within the range of 1,327 cm⁻¹±10 cm⁻¹ (difference between the maximum peak within the range of 1,327 cm⁻¹±10 cm⁻¹ and the minimum peak within the range of from 300 cm⁻¹ to 1,800 cm⁻¹) to a peak intensity B1 within the range of 1,531 cm⁻¹±10 cm⁻¹ (difference between the maximum peak within the range of 1,531 cm⁻¹±10 cm⁻¹ and the minimum peak within the range of from 300 cm⁻¹ to 1,800 cm⁻¹) is preferably from 0.30 to 5.0, more preferably from 0.50 to 4.5, still more preferably from 0.70 to 4.0, most preferably from 0.80 to 3.5.

The Raman spectrum described above may be measured with NRS-3100 manufactured by JASCO Corporation (excitation wavelength: λ=532 nm, grating: 600 l/mm, resolution: 1 cm⁻¹, exposure time: 30 seconds, slit width: φ50 μm).

### (2-1-1-2) Other Sulfur-modified Acrylic Compound

In this disclosure, the other sulfur-modified acrylic compound is obtained by, for example, a method including heating elemental sulfur and a homopolymer or copolymer of any other acrylic monomer free of a constituent unit derived from acrylonitrile or methacrylonitrile. As the other acrylic monomer, the same monomer as the other acrylic monomer described in the section “(2-1-1-1) Sulfur-modified Polyacrylonitrile-based Compound” may be used.

### (2-1-2) Sulfur-modified Polynuclear Aromatic Compound

For example, a compound in which a sulfur atom and an atom in a polynuclear aromatic compound are covalently bonded to each other may be used as the sulfur-modified polynuclear aromatic compound in this disclosure. The sulfur-modified polynuclear aromatic compound may be produced by, for example, heating a mixture of elemental sulfur and a polynuclear aromatic compound serving as an organic compound.

Examples of the polynuclear aromatic compound include: a benzene-based aromatic compound, such as naphthalene, anthracene, tetracene, pentacene, phenanthrene, chrysene, picene, pyrene, benzopyrene, perylene, or coronene; an aromatic compound in which part of the benzene-based aromatic compound is a five-membered ring; and a heteroatom-containing heteroaromatic compound in which part of carbon atoms of the aromatic compound are each substituted with sulfur, oxygen, or nitrogen. Further, those polynuclear aromatic compounds may each have a substituent, such as a chain or branched alkyl group having 1 to 12 carbon atoms, an alkoxyl group, a hydroxyl group, a carboxyl group, an amino group, an aminocarbonyl group, an aminothio group, a mercaptothiocarbonylamino group, or a carboxyalkylcarbonyl group.

The sulfur content when the sulfur-modified compound is a sulfur-modified polynuclear aromatic compound is not particularly limited, but preferably falls within the range of from 10 mass % to 80 mass %, more preferably falls within the range of from 20 mass % to 80 mass %, still more preferably falls within the range of from 30 mass % to 80 mass %, still more preferably falls within the range of from 35 mass % to 75 mass %, still more preferably falls within the range of from 40 mass % to 75 mass %, still more preferably falls within the range of from 45 mass % to 70 mass %, still more preferably falls within the range of from 45 mass % to 65 mass %, and most preferably falls within the range of from 45 mass % to 60 mass % from the viewpoint that the discharge capacity is further increased.

### (2-1-3) Sulfur-modified Polyether Compound

The same compound as that described in JP 2022-65974 A may be used as the sulfur-modified polyether compound.

### (2-2) Production Method

A method of producing the above-mentioned sulfur-modified compound has only to be a method capable of producing a sulfur-modified compound having a desired sulfur content, and may be, for example, a method including a heating step of heating a mixture of elemental sulfur and an organic compound. The production method may be a method including a mechanochemical treatment step of subjecting the heat-treated product after the heating step to mechanochemical treatment.

The heating step in the production method is a step of heating the mixture of the elemental sulfur and the organic compound. In the heating step, under a non-oxidizing atmosphere, heating to from 200° C. to 600° C. is preferred, and heating to from 250° C. to 500° C. is more preferred from the viewpoint that the discharge capacity is increased and the safety of the lithium ion secondary battery is improved.

The mechanochemical treatment in the mechanochemical treatment step refers to treatment of causing a chemical reaction, which utilizes high energy locally generated by mechanical energy, such as friction or compression energy, in a pulverization process of a solid substance. The above-mentioned production method preferably includes the mechanochemical treatment step from the viewpoint that the sulfur content is easily adjusted. It is assumed that, in the mechanochemical treatment, the ratio of the sulfur for forming a covalent bond and the like with an atom derived from the organic compound contained in the sulfur-modified compound is easily increased. More specifically, it is inferred that the mechanochemical treatment can cause the elemental sulfur (e.g., elemental sulfur that has not reacted in the heating step) in the heat-treated product to react with the sulfur-modified compound.

In the mechanochemical treatment, for example, mechanical energy, such as impact, friction, compression, or shear energy, may be caused to act on the heat-treated product, or a combination thereof may be caused to act thereon. A known apparatus may be used as an apparatus for performing the mechanochemical treatment, and examples thereof include: a mixing apparatus, such as a ball mill, a vibration mill, a planetary ball mill, a cyclone mill, or a medium stirring-type mill; a pulverizer, such as a ball medium mill, a roller mill, or a mortar; and a jet pulverizer capable of mainly causing a force, such as an impact or grinding force, to act on the heat-treated product.

In this disclosure, the apparatus is preferably a mixing apparatus, such as a ball mill, a vibration mill, a planetary ball mill, a cyclone mill, or a medium stirring-type mill, or a pulverizer, such as a ball medium mill, a roller mill, or a mortar, more preferably a mixing apparatus, such as a ball mill, a vibration mill, a planetary ball mill, or a medium stirring-type mill, still more preferably a ball mill, a vibration mill, a planetary ball mill, or a cyclone mill from the viewpoint that the discharge capacity is further increased.

An environment for performing the mechanochemical treatment may be under an oxidizing atmosphere or under a non-oxidizing atmosphere, but is preferably under a non-oxidizing atmosphere. The oxidizing atmosphere refers to an atmosphere containing an oxidizing gas, and is, for example, an atmosphere containing oxygen, ozone, or nitrogen dioxide. The non-oxidizing atmosphere refers to an atmosphere free of an oxidizing gas, and is, for example, an atmosphere formed of nitrogen or argon.

In this disclosure, the environment for performing the mechanochemical treatment is preferably under a non-oxidizing atmosphere formed of nitrogen or argon, more preferably under a non-oxidizing atmosphere formed of nitrogen from the viewpoint that the discharge capacity is increased and the safety of the lithium ion secondary battery is improved.

The production method may be a method including any other step except the heating step and the mechanochemical treatment step. An example of the other step may be a sulfur content adjustment step of adjusting an elemental sulfur content of the heat-treated product obtained in the heating step, which is performed between the heating step and the mechanochemical treatment step.

In the sulfur content adjustment step, the elemental sulfur may be additionally supplied to the heat-treated product to increase the sulfur content in the heat-treated product to be used in the mechanochemical treatment step, or the elemental sulfur may be removed from the heat-treated product so that the content of the elemental sulfur in the heat-treated product to be used in the mechanochemical treatment step is reduced.

### (3) Charge and Discharge Treatment

The charge and discharge treatment in the above-mentioned charge and discharge treatment step has only to be a method capable of charging and discharging the first lithium ion secondary battery. Examples thereof include the occlusion and release of chemical species serving as charge carriers (e.g., ions such as lithium ions).

In the charge and discharge treatment, it is preferred that discharge be performed under conditions where the discharge end potential of the positive electrode is from 0.3 V (hereinafter sometimes referred to as “V(Li⁺/Li)”) to 1.8 V(Li⁺/Li) based on a lithium redox potential, it is more preferred that discharge be performed under conditions where the discharge end potential of the positive electrode is from 0.5 V(Li⁺/Li) to 1.3 V(Li⁺/Li), it is still more preferred that discharge be performed under conditions where the discharge end potential of the positive electrode is from 0.8 V(Li⁺/Li) to 1.2 V(Li⁺/Li), and it is most preferred that discharge be performed under conditions where the discharge end potential of the positive electrode is from 0.9 V(Li⁺/Li) to 1.1 V(Li⁺/Li), from the viewpoint that the discharge capacity is increased and an excellent cycle characteristic is exhibited.

In the charge and discharge treatment, it is preferred that charge be performed under conditions where the charge end potential of the positive electrode is from 2.0 V(Li⁺/Li) to 4.3 V(Li⁺/Li), it is more preferred that charge be performed under conditions where the charge end potential of the positive electrode is from 2.7 V(Li⁺/Li) to 4.0 V(Li⁺/Li), it is still more preferred that charge be performed under conditions where the charge end potential of the positive electrode is from 2.8 V(Li⁺/Li) to 3.5 V(Li⁺/Li), it is still more preferred that charge be performed under conditions where the charge end potential of the positive electrode is from 2.9 V(Li⁺/Li) to 3.3 V(Li⁺/Li), and it is most preferred that charge be performed under conditions where the charge end potential of the positive electrode is from 2.9 V(Li⁺/Li) to 3.1 V(Li⁺/Li), from the viewpoint that the discharge capacity is increased and an excellent cycle characteristic is exhibited.

The number of cycles of charge and discharge in the charge and discharge treatment preferably falls within the range of from 1 to 20, more preferably falls within the range of from 1 to 15, still more preferably falls within the range of from 1 to 13, still more preferably falls within the range of from 1 to 10, still more preferably falls within the range of from 1 to 8, and most preferably falls within the range of from 3 to 8, from the viewpoint that the discharge capacity is increased and an excellent cycle characteristic is exhibited. In this disclosure, one cycle represents a cycle of charge and discharge, but the first cycle may be only discharge.

The C-rate at which the charge and discharge are performed in the charge and discharge treatment preferably falls within the range of from 0.01C (i.e., 100-hour charge and 100-hour discharge) to 5C (i.e., 0.2-hour charge and 0.2-hour discharge), more preferably falls within the range of from 0.05C (i.e., 20-hour charge and 20-hour discharge) to 2C (i.e., 0.5-hour charge and 0.5-hour discharge) or less, and most preferably falls within the range of from 0.1C (i.e., 10-hour charge and 10-hour discharge) to 1C (i.e., 1-hour charge and 1-hour discharge), from the viewpoint that the discharge capacity is increased and an excellent cycle characteristic is exhibited.

The temperature at which the charge and discharge are performed in the charge and discharge treatment preferably falls within the range of from 10° C. to 60° C., more preferably falls within the range of from 10° C. to 50° C., still more preferably falls within the range of from 15° C. to 50° C., and most preferably falls within the range of from 20° C. to 45° C., from the viewpoint that the discharge capacity is increased and an excellent cycle characteristic is exhibited.

### 2. Replacement Step

The replacement step in this disclosure is a step of replacing the first liquid electrolyte included in the first lithium ion secondary battery with a second liquid electrolyte to provide a second lithium ion secondary battery after the above-mentioned charge and discharge treatment step. That is, the first lithium ion secondary battery is disassembled, the first liquid electrolyte among the constituent elements of the first lithium ion secondary battery is taken out and replaced with the second liquid electrolyte. Thus, the second lithium ion secondary battery that is the lithium ion secondary battery of this disclosure can be produced. In addition, the replacement step may include a step of washing the positive electrode, the negative electrode, and the like of the first lithium ion secondary battery with dimethyl carbonate (DMC) or the like as appropriate after taking out the first liquid electrolyte. The replacement step is preferably performed under an atmosphere having a dew-point temperature of from −100° C. to −30° C. from the viewpoint that the discharge capacity is increased and an excellent cycle characteristic is exhibited.

The negative electrode of the first lithium ion secondary battery may be used as it is, or a fresh negative electrode may be used as the negative electrode. In addition, the separator of the first lithium ion secondary battery may be used as it is, or a fresh separator may be used as the separator.

### (1) Second Liquid Electrolyte

A liquid electrolyte obtained by dissolving a supporting electrolyte in a solvent selected from the group consisting of: a saturated cyclic ether compound; and a saturated chain ether compound may be used as the second liquid electrolyte.

In this disclosure, the density at 25° C. of the second liquid electrolyte preferably falls within the range of from 0.80 g/cm³ to 1.20 g/cm³, more preferably falls within the range of from 0.80 g/cm³ to 1.19 g/cm³, still more preferably falls within the range of from 0.81 g/cm³ to 1.18 g/cm³, and most preferably falls within the range of from 0.82 g/cm³ to 1.18 g/cm³ from the viewpoint that a lithium ion secondary battery having an increased discharge capacity, an excellent cycle characteristic, and a light weight is obtained.

The density at 25° C. was measured with a 5 ml Gay-Lussac type pycnometer under the condition of 25° C. in conformity with JIS Z 8804:2012 “6. Methods of measuring density and specific gravity with pycnometer.”

The same supporting electrolyte as that described in the section “(1-3) First Liquid Electrolyte” of “1. Charge and Discharge Treatment Step” in “A. Method of producing Lithium Ion Secondary Battery” may be used as the supporting electrolyte used for the second liquid electrolyte.

The content of the supporting electrolyte in the second liquid electrolyte is preferably from 0.3 mol/L to 7 mol/L, more preferably from 0.5 mol/L to 1.8 mol/L from the viewpoint that the discharge capacity is further increased.

The solvent used for the second liquid electrolyte has only to include one or more kinds selected from the group consisting of: a saturated cyclic ether compound; and a saturated chain ether compound. The solvent may be used in combination with any other solvent, such as a silane, acetonitrile, propionitrile, nitromethane, a derivative thereof, or various ionic liquids, as long as the other solvent does not adversely affect the lithium ion secondary battery of this disclosure.

The content of a compound selected from the group consisting of: a saturated cyclic ether compound; and a saturated chain ether compound in the solvent of the second liquid electrolyte is preferably 60 vol % or more, more preferably 80 vol % or more, still more preferably 85 vol % or more, still more preferably 90 vol % or more, still more preferably 95 vol % or more, most preferably 98 vol % or more from the viewpoint that the discharge capacity is increased and an excellent cycle characteristic is exhibited.

In this disclosure, the term “vol %” refers to a volume ratio measured under an environment of 25° C.

Examples of the saturated cyclic ether compound and the saturated chain ether compound include 1,2-dimethoxyethane, ethoxymethoxyethane, diethoxyethane, tetrahydrofuran, 1,3-dioxolane, 2-methyl-1,3-dioxolane, dioxane, 1,2-bis(methoxycarbonyloxy) ethane, 1,2-bis(ethoxycarbonyloxy) ethane, 1,2-bis(ethoxycarbonyloxy) propane, ethylene glycol bis(trifluoroethyl) ether, propylene glycol bis(trifluoroethyl) ether, diethyl ether, dipropyl ether, methyl propyl ether, methyl butyl ether, propyl butyl ether, ethylene glycol bis(trifluoromethyl) ether, diethylene glycol bis(trifluoroethyl) ether, 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, tris(2,2,2-trifluoroethyl) orthoformic acid, and glymes. Those solvents may be used alone or in combination thereof.

In this disclosure, among the above-mentioned saturated cyclic ether compounds and saturated chain ether compounds, one or more kinds selected from the group consisting of: 1,2-dimethoxyethane; tetrahydrofuran; 1,3-dioxolane; dipropyl ether; methyl propyl ether; and glymes are preferably used from the viewpoint that a lithium ion secondary battery having an increased discharge capacity, an excellent cycle characteristic, and a light weight can be formed.

For example, to prolong the lifetime of the lithium ion secondary battery and improve the safety thereof, the second liquid electrolyte may contain any other known additive, such as an electrode film forming agent, an antioxidant, a flame retardant, or an overcharge inhibitor. The content of the other additive is generally from 0.01 part by mass to 10 parts by mass, preferably from 0.1 part by mass to 5 parts by mass with respect to 100 parts by mass of the second liquid electrolyte from the viewpoint that the discharge capacity is further increased.

### (2) Negative Electrode of Second Lithium Ion Secondary Battery

In this disclosure, the negative electrode of the first lithium ion secondary battery may be used as it is, or a fresh negative electrode may be used as the negative electrode of the second lithium ion secondary battery. The same negative electrode as that described in the section “(1-2) Negative Electrode” of “1. Charge and Discharge Treatment Step” in “A. Method of producing Lithium Ion Secondary Battery” may be used as the fresh negative electrode, and hence description thereof is omitted in this section.

### B. Others

This disclosure includes the following aspects.
[1] A method of producing a lithium ion secondary battery, the method including:
a charge and discharge treatment step of subjecting a first lithium ion secondary battery including a positive electrode having a positive electrode active material layer containing a sulfur-modified compound, a first liquid electrolyte, and a negative electrode to charge and discharge treatment; and
a replacement step of replacing the first liquid electrolyte with a second liquid electrolyte to provide a second lithium ion secondary battery after the charge and discharge treatment step,
wherein the first liquid electrolyte contains a solvent selected from the group consisting of: a saturated cyclic carbonate compound; and a saturated chain carbonate compound, and
wherein the second liquid electrolyte contains a solvent selected from the group consisting of: a saturated cyclic ether compound; and a saturated chain ether compound.
[2] The method of producing a lithium ion secondary battery according to Item [1], wherein the sulfur-modified compound is a sulfur-modified acrylic compound.
[3] The method of producing a lithium ion secondary battery according to Item [2], wherein the sulfur-modified acrylic compound is a sulfur-modified polyacrylonitrile-based compound.
[4] The method of producing a lithium ion secondary battery according to any one of Items [1] to [3], wherein a sulfur content of the sulfur-modified compound falls within a range of from 10 mass % to 80 mass %.
[5] The method of producing a lithium ion secondary battery according to any one of Items [1] to [4],
   wherein a density at 25° C. of the first liquid electrolyte falls within a range of from 1.21 g/cm³ to 1.60 g/cm³, and
   wherein a density at 25° C. of the second liquid electrolyte falls within a range of from 0.80 g/cm³ to 1.20 g/cm³.
[6] The method of producing a lithium ion secondary battery according to any one of Items [1] to [5], wherein the charge and discharge treatment step includes performing discharge under conditions where a discharge end potential of the positive electrode is from 0.3 V(Li⁺/Li) to 1.8 V(Li⁺/Li), and performing charge under conditions where a charge end potential of the positive electrode is from 2.0 V(Li⁺/Li) to 4.3 V(Li⁺/Li).

This disclosure is not limited to the above-mentioned embodiments. The above-mentioned embodiments are illustrative, and any embodiment having substantially the same configuration as that of the technical idea described in Claims and exhibiting an action and effect similar thereto is encompassed in the technical scope of this disclosure.

### EXAMPLES

This disclosure is described in more detail below by way of Examples and Comparative Examples. However, this disclosure is by no means limited to the following Examples and the like. “Part(s)” and “%” in Examples are by mass unless otherwise specified.

### Production Example 1: Production of Sulfur-modified Compound

Only a heating step was performed by a method in conformity with Production Examples of JP 2013-054957 A. Specifically, 20 g of a raw material polyacrylonitrile mixture (hereinafter sometimes referred to as “raw material PAN mixture”) obtained by mixing 10 parts by mass of polyacrylonitrile powder (manufactured by Sigma-Aldrich, average particle diameter: 200 μm) and 30 parts by mass of elemental sulfur (manufactured by Sigma-Aldrich, average particle diameter: 200 μm) was loaded into a bottomed cylindrical glass tube having an outer diameter of 45 mm and a length of 120 mm, and a silicone plug including a gas introduction tube and a gas discharge tube was then installed in an opening of the glass tube. After air inside the glass tube was replaced with nitrogen, a lower portion of the glass tube was inserted into a crucible-type electric furnace, and was heated at 400° C. for 1 hour while hydrogen sulfide to be generated was removed by introducing nitrogen from the gas introduction tube. Thus, a heat-treated product 1 was obtained. Sulfur vapor was refluxed by being condensed in an upper portion or a lid portion of the glass tube.

The resultant heat-treated product 1 was placed in a glass tube oven at 260° C., and was heated at a pressure reduced to 20 hPa for 3 hours so that the elemental sulfur was removed therefrom. Thus, a sulfur-containing material A that was a sulfur-modified polyacrylonitrile-based compound was obtained.

### Production Example 2: Production of Sulfur-Carbon Composite Compound

20 g of a mixture obtained by mixing 75 parts by mass of elemental sulfur (manufactured by Sigma-Aldrich, average particle diameter: 200 μm) and 25 parts by mass of Ketjen black (manufactured by Lion Corporation, EC600JD) was loaded into a bottomed cylindrical glass tube having an outer diameter of 45 mm and a length of 120 mm, and a silicone plug including a gas introduction tube and a gas discharge tube was then installed in an opening of the glass tube. After air inside the glass tube was replaced with nitrogen, a lower portion of the glass tube was inserted into a crucible-type electric furnace, and was heated at 155° C. for 12 hours while the inside of the glass tube was sealed. Thus, a sulfur-containing material “a” that was a sulfur-carbon composite compound was obtained. The sulfur-containing material “a” is not a compound having a covalent bond and the like formed from sulfur and an atom in an organic compound, and hence does not correspond to a sulfur-modified compound.

### [Sulfur Content]

The sulfur content of each of the sulfur-containing material A and the sulfur-containing material “a” was calculated from the results of analysis with a CHNS analyzer (manufactured by Elementar Analysensysteme GmbH, model: vario MICRO cube) capable of analyzing sulfur and oxygen. The temperatures of a combustion tube and a reduction tube were set to 1,150° C. and 850° C., respectively, and a tin boat was used as a sample container.

From the results of analysis, the sulfur content of the sulfur-containing material A was 48.0 mass %, and the sulfur content of the sulfur-containing material “a” was 75.0 mass %.

### [Production of Lithium Ion Secondary Battery]

A lithium ion secondary battery was produced through use of the above-mentioned sulfur-containing material A or sulfur-containing material “a”.

### (1) Preparation of Positive Electrode

94.0 Parts by mass of the sulfur-containing material A or the sulfur-containing material “a” serving as a positive electrode active material, 2.5 parts by mass of acetylene black (manufactured by Denka Company Limited) and 0.5 part by mass of a single-walled carbon nanotube (manufactured by OCSiAI) serving as conductive assistants, 1.5 parts by mass of a styrene-butadiene rubber (aqueous dispersion, manufactured by Zeon Corporation) and 1.5 parts by mass of sodium carboxymethyl cellulose (manufactured by Daicel Fine Chem Ltd.) serving as binders, and 120 parts by mass of water serving as a solvent were mixed with a rotation/revolution mixer to prepare a composition for forming a positive electrode active material layer.

In the case of the sulfur-containing material A, the composition for forming a positive electrode active material layer was applied onto carbon-coated aluminum foil (thickness: 20 μm) by a doctor blade method, and was dried at 90° C. for 1 hour. After that, the electrode was cut into a predetermined size and dried under a vacuum at 130° C. for 2 hours to prepare a disc-shaped positive electrode.

In the case of the sulfur-containing material “a”, the composition for forming a positive electrode active material layer was applied onto carbon-coated aluminum foil (thickness: 20 μm) by a doctor blade method, and was dried at 80° C. for 1 hour. After that, the electrode was cut into a predetermined size and dried under a nitrogen atmosphere at 80° C. for 1 hour to prepare a disc-shaped positive electrode.

### (2) Preparation of Negative Electrode

Metal lithium having a thickness of 500 μm was cut into a predetermined size to prepare a disc-shaped negative electrode.

### (3) Preparation of Liquid Electrolyte

### (3-1) Liquid Electrolyte A

A liquid electrolyte A was prepared by dissolving LiPFs at a concentration of 1.0 mol/L in a mixed solvent formed of 50 vol % of fluoroethylene carbonate and 50 vol % of diethyl carbonate.

The density at 25° C. of the liquid electrolyte A, which was determined with a 5 ml Gay-Lussac type pycnometer under the condition of 25° C. in conformity with JIS Z 8804:2012 “6. Methods of measuring density and specific gravity with pycnometer,” was 1.32 g/cm³.

### (3-2) Liquid Electrolyte B

A liquid electrolyte B was prepared by dissolving LiPF₆ at a concentration of 1.0 mol/L in a mixed solvent formed of 50 vol % of ethylene carbonate and 50 vol % of diethyl carbonate.

The density at 25° C. of the liquid electrolyte B, which was determined with a 5 ml Gay-Lussac type pycnometer under the condition of 25° C. in conformity with JIS Z 8804:2012 “6. Methods of measuring density and specific gravity with pycnometer,” was 1.25 g/cm³.

### (3-3) Liquid Electrolyte C

A liquid electrolyte C was prepared by dissolving LiPF₆ at a concentration of 1.0 mol/L in a mixed solvent formed of 30 vol % of ethylene carbonate and 70 vol % of ethyl methyl carbonate.

The density at 25° C. of the liquid electrolyte C, which was determined with a 5 ml Gay-Lussac type pycnometer under the condition of 25° C. in conformity with JIS Z 8804:2012 “6. Methods of measuring density and specific gravity with pycnometer,” was 1.22 g/cm³.

### (3-4) Liquid Electrolyte D

A liquid electrolyte D was prepared by dissolving LiN(CF₃SO₂)₂ at a concentration of 1.0 mol/L in a mixed solvent formed of 50 vol % of 1,2-dimethoxyethane and 50 vol % of 1,3-dioxolane, and then adding LiNO₃ in an amount of 2 parts by mass with respect to 100 parts by mass of the total amount of the whole liquid electrolyte.

The density at 25° C. of the liquid electrolyte D, which was determined with a 5 ml Gay-Lussac type pycnometer under the condition of 25° C. in conformity with JIS Z 8804:2012 “6. Methods of measuring density and specific gravity with pycnometer,” was 1.17 g/cm³.

### (3-5) Liquid Electrolyte E

A liquid electrolyte E was prepared by dissolving LiN(CF₃SO₂)₂ at a concentration of 0.4 mol/L, lithium 1,1,2,2,3,3-hexafluoropropane-1,3-disulfonimide at a concentration of 0.1 mol/L, and LiNO₃ at a concentration of 0.4 mol/L in a mixed solvent formed of 48 vol % of 1,2-dimethoxyethane, 17 vol % of 1,3-dioxolane, and 35 vol % of (trifluoromethyl)trimethylsilane.

The density at 25° C. of the liquid electrolyte E, which was determined with a 5 ml Gay-Lussac type pycnometer under the condition of 25° C. in conformity with JIS Z 8804:2012 “6. Methods of measuring density and specific gravity with pycnometer,” was 1.02 g/cm³.

### (3-6) Liquid Electrolyte F

A liquid electrolyte F was prepared by dissolving LiN(CF₃SO₂)₂ at a concentration of 0.2 mol/L and LiNO₃ at a concentration of 0.4 mol/L in a mixed solvent formed of 48 vol % of 1,2-dimethoxyethane and 52 vol % of methyl propyl ether.

The density at 25° C. of the liquid electrolyte F, which was determined with a 5 ml Gay-Lussac type pycnometer under the condition of 25° C. in conformity with JIS Z 8804:2012 “6. Methods of measuring density and specific gravity with pycnometer,” was 0.83 g/cm³.

### (3-7) Liquid Electrolyte G

A liquid electrolyte G was prepared by dissolving LiN(CF₃SO₂)₂ at a concentration of 0.2 mol/L, LiN(SO₂F)₂ at a concentration of 0.2 mol/L, lithium 1,1,2,2,3,3-hexafluoropropane-1,3-disulfonimide at a concentration of 0.1 mol/L, and LiNO₃ at a concentration of 0.1 mol/L in a mixed solvent formed of 75 vol % of 1,2-dimethoxyethane, 5 vol % of 1,3-dioxolane, and 20 vol % of (trifluoromethyl)trimethylsilane.

The density at 25° C. of the liquid electrolyte G, which was determined with a 5 mL Gay-Lussac type pycnometer under the condition of 25° C. in conformity with JIS Z 8804:2012 “6. Methods of measuring density and specific gravity with pycnometer,” was 0.98 g/cm³.

A lithium ion secondary battery was prepared and subjected to a battery evaluation in accordance with each of the following conditions (4-1) and (4-2).

### (4-1) Production of Lithium Ion Secondary Battery

The positive electrode and the negative electrode prepared in advance were held in a case while a glass filter serving as a separator was sandwiched therebetween. After that, each of the first liquid electrolytes shown in Table 1 was injected into the case, and the case was hermetically sealed. Thus, lithium ion secondary batteries (coin-shaped batteries each having a diameter of 20 mm and a thickness of 3.2 mm) were each produced. This production was performed under an atmosphere having a dew-point temperature of −70° C.

### [Charge and Discharge Treatment Step]

Each of the lithium ion secondary batteries produced in the foregoing was placed in a constant-temperature bath at 30° C., and was subjected to 10 cycles of charge and discharge at a charge rate of 0.1C and a discharge rate of 0.1C under the following conditions: the charge end potential of the positive electrode was set to 3.0 V(Li⁺/Li) and the discharge end potential of the positive electrode was set to 1.0 V(Li⁺/Li), that is, the charge end voltage was set to 3.0 V and the discharge end voltage was set to 1.0 V.

### [Replacement Step]

The lithium ion secondary battery subjected to the charge and discharge treatment step was disassembled, the positive electrode, the negative electrode, and the glass filter were taken out of the case, and the positive electrode was washed with dimethyl carbonate (DMC).

The washed positive electrode, a newly prepared negative electrode, and a newly prepared glass filter serving as a separator were held in a new case. After that, each of the predetermined second liquid electrolytes shown in Table 1 was injected into the case, and the case was hermetically sealed. Thus, lithium ion secondary batteries (coin-shaped batteries each having a diameter of 20 mm and a thickness of 3.2 mm) were each produced. This step was performed under an atmosphere having a dew-point temperature of −70° C.

### [Battery Evaluation]

Each of the lithium ion secondary batteries produced through the replacement step was placed in a constant-temperature bath at 30° C., and was subjected to 200 cycles of charge and discharge at a charge rate of 0.5C and a discharge rate of 0.5C under the following conditions: the charge end potential of the positive electrode was set to 3.0 V(Li⁺/Li) and the discharge end potential of the positive electrode was set to 1.0 V(Li⁺/Li), that is, the charge end voltage was set to 3.0 V and the discharge end voltage was set to 1.0 V. Discharge capacities (mAh/g) were measured in the 5th cycle and the 200th cycle. The results of the discharge capacity (mAh/g) in the 5th cycle are shown in Table 1. In this disclosure, “g” in the discharge capacity (mAh/g) refers to the mass of the active material in the positive electrode active material layer.

In addition, a ratio of the discharge capacity in the 200th cycle to the discharge capacity in the 5th cycle was used as a capacity retention rate (%), and a cycle characteristic was evaluated. The results are shown in Table 1.

In each of Comparative Examples in which the first liquid electrolyte is the same as the second liquid electrolyte, its battery evaluation is synonymous with a general battery evaluation not subjected to a charge and discharge treatment step.

TABLE 1

| | | | | Density of | Discharge | Capacity |
|---|---|---|---|---|---|---|
| | Used positive | | | second liquid | capacity in | retention |
| | electrode | First liquid | Second liquid | electrolyte | 5th cycle | rate |
| | active material | electrolyte | electrolyte | (g/cm³) | (mAh/g) | (%) |
| Example 1 | Sulfur- | Liquid | Liquid | 1.17 | 630 | 97 |
| | containing | electrolyte A | electrolyte D | | | |
| | material A | | | | | |
| Example 2 | Sulfur- | Liquid | Liquid | 1.02 | 630 | 96 |
| | containing | electrolyte A | electrolyte E | | | |
| | material A | | | | | |
| Example 3 | Sulfur- | Liquid | Liquid | 0.83 | 629 | 96 |
| | containing | electrolyte A | electrolyte F | | | |
| | material A | | | | | |
| Example 4 | Sulfur- | Liquid | Liquid | 0.98 | 629 | 97 |
| | containing | electrolyte A | electrolyte G | | | |
| | material A | | | | | |
| Example 5 | Sulfur- | Liquid | Liquid | 1.17 | 630 | 88 |
| | containing | electrolyte B | electrolyte D | | | |
| | material A | | | | | |
| Comparative | Sulfur- | Liquid | Liquid | 1.25 | 630 | 90 |
| Example 1 | containing | electrolyte B | electrolyte B | | | |
| | material A | | | | | |
| Comparative | Sulfur- | Liquid | Liquid | 1.32 | 631 | 99 |
| Example 2 | containing | electrolyte A | electrolyte A | | | |
| | material A | | | | | |
| Comparative | Sulfur- | Liquid | Liquid | 1.17 | 625 | 81 |
| Example 3 | containing | electrolyte D | electrolyte D | | | |
| | material A | | | | | |
| Comparative | Sulfur- | Liquid | Liquid | 1.02 | 610 | 75 |
| Example 4 | containing | electrolyte E | electrolyte E | | | |
| | material A | | | | | |
| Comparative | Sulfur- | Liquid | Liquid | 0.83 | 608 | 70 |
| Example 5 | containing | electrolyte F | electrolyte F | | | |
| | material A | | | | | |
| Comparative | Sulfur- | Liquid | Liquid | 0.98 | 615 | 80 |
| Example 6 | containing | electrolyte G | electrolyte G | | | |
| | material A | | | | | |
| Comparative | Sulfur- | Liquid | Liquid | 1.32 | 626 | 88 |
| Example 7 | containing | electrolyte D | electrolyte A | | | |
| | material A | | | | | |
| Comparative | Sulfur- | Liquid | Liquid | 1.02 | 616 | 77 |
| Example 8 | containing | electrolyte D | electrolyte E | | | |
| | material A | | | | | |
| Comparative | Sulfur- | Liquid | Liquid | 1.32 | 0 | 0 |
| Example 9 | containing | electrolyte A | electrolyte A | | | |
| | material “a” | | | | | |
| Comparative | Sulfur- | Liquid | Liquid | 1.17 | 0 | 0 |
| Example 10 | containing | electrolyte A | electrolyte D | | | |
| | material “a” | | | | | |
| Comparative | Sulfur- | Liquid | Liquid | 1.17 | 0 | 0 |
| Example 11 | containing | electrolyte B | electrolyte D | | | |
| | material “a” | | | | | |

### (4-2) Production of Lithium Ion Secondary Battery

The positive electrode and the negative electrode prepared in advance were held in a case while a glass filter serving as a separator was sandwiched therebetween. After that, each of the first liquid electrolytes shown in Table 2 was injected into the case, and the case was hermetically sealed. Thus, lithium ion secondary batteries (coin-shaped batteries each having a diameter of 20 mm and a thickness of 3.2 mm) were each produced. This production was performed under an atmosphere having a dew-point temperature of −70° C.

### [Charge and Discharge Treatment Step]

Each of the lithium ion secondary batteries produced in the foregoing was placed in a constant-temperature bath at 30° C., and was subjected to 5 cycles of charge and discharge at a charge rate of 0.1C and a discharge rate of 0.1C under the following conditions: the charge end potential of the positive electrode was set to 3.5 V(Li⁺/Li) and the discharge end potential of the positive electrode was set to 0.3 V(Li⁺/Li), that is, the charge end voltage was set to 3.5 V and the discharge end voltage was set to 0.3 V.

### [Replacement Step]

The lithium ion secondary battery subjected to the charge and discharge treatment step was disassembled, the positive electrode, the negative electrode, and the glass filter were taken out of the case, and the positive electrode was washed with dimethyl carbonate (DMC).

The washed positive electrode, a newly prepared negative electrode, and a newly prepared glass filter serving as a separator were held in a new case. After that, each of the predetermined second liquid electrolytes shown in Table 2 was injected into the case, and the case was hermetically sealed. Thus, lithium ion secondary batteries (coin-shaped batteries each having a diameter of 20 mm and a thickness of 3.2 mm) were each produced. This step was performed under an atmosphere having a dew-point temperature of −70° C.

### [Battery Evaluation]

Each of the lithium ion secondary batteries produced through the replacement step was placed in a constant-temperature bath at 30° C., and was subjected to 200 cycles of charge and discharge at a charge rate of 0.5C and a discharge rate of 0.5C under the following conditions: the charge end potential of the positive electrode was set to 3.5 V(Li⁺/Li) and the discharge end potential of the positive electrode was set to 0.3 V(Li⁺/Li), that is, the charge end voltage was set to 3.5 V and the discharge end voltage was set to 0.3 V. Discharge capacities (mAh/g) were measured in the 5th cycle and the 200th cycle. The results of the discharge capacity (mAh/g) in the 5th cycle are shown in Table 2. In this disclosure, “g” in the discharge capacity (mAh/g) refers to the mass of the active material in the positive electrode active material layer.

In addition, a ratio of the discharge capacity in the 200th cycle to the discharge capacity in the 5th cycle was used as a capacity retention rate (%), and a cycle characteristic was evaluated. The results are shown in Table 2.

In Comparative Example in which the first liquid electrolyte is the same as the second liquid electrolyte, its battery evaluation is synonymous with a general battery evaluation not subjected to a charge and discharge treatment step.

TABLE 2

| | | | | Density of | Discharge | Capacity |
|---|---|---|---|---|---|---|
| | Used positive | | | second liquid | capacity in | retention |
| | electrode | First liquid | Second liquid | electrolyte | 5th cycle | rate |
| | active material | electrolyte | electrolyte | (g/cm³) | (mAh/g) | (%) |
| Example 6 | Sulfur- | Liquid | Liquid | 0.98 | 905 | 88 |
| | containing | electrolyte A | electrolyte G | | | |
| | material A | | | | | |
| Comparative | Sulfur- | Liquid | Liquid | 0.98 | 872 | 70 |
| Example 12 | containing | electrolyte G | electrolyte G | | | |
| | material A | | | | | |
| Comparative | Sulfur- | Liquid | Liquid | 0.98 | 0 | 0 |
| Example 13 | containing | electrolyte A | electrolyte G | | | |
| | material “a” | | | | | |

From the above-mentioned results, it was found that the lithium ion secondary battery subjected to the charge and discharge treatment step and the replacement step of each of Examples had an increased discharge capacity, had an excellent cycle characteristic (capacity retention rate), and was light-weight because the second liquid electrolyte having a low density was used. Accordingly, the method of producing a lithium ion secondary battery of this disclosure can provide the lithium ion secondary battery having a large discharge capacity, an excellent cycle characteristic, and a light weight.

1. A method of producing a lithium ion secondary battery, the method comprising:
a charge and discharge treatment step of subjecting a first lithium ion secondary battery including a positive electrode having a positive electrode active material layer containing a sulfur-modified compound, a first liquid electrolyte, and a negative electrode to charge and discharge treatment; and
a replacement step of replacing the first liquid electrolyte with a second liquid electrolyte to provide a second lithium ion secondary battery after the charge and discharge treatment step,
wherein the first liquid electrolyte contains a solvent selected from the group consisting of: a saturated cyclic carbonate compound; and a saturated chain carbonate compound, and
wherein the second liquid electrolyte contains a solvent selected from the group consisting of: a saturated cyclic ether compound; and a saturated chain ether compound.

2. The method of producing a lithium ion secondary battery according to claim 1, wherein the sulfur-modified compound is a sulfur-modified acrylic compound.

3. The method of producing a lithium ion secondary battery according to claim 2, wherein the sulfur-modified acrylic compound is a sulfur-modified polyacrylonitrile-based compound.

4. The method of producing a lithium ion secondary battery according to claim 1, wherein a sulfur content of the sulfur-modified compound falls within a range of from 10 mass % to 80 mass %.

5. The method of producing a lithium ion secondary battery according to claim 1,
wherein a density at 25° C. of the first liquid electrolyte falls within a range of from 1.21 g/cm³ to 1.60 g/cm³, and
wherein a density at 25° C. of the second liquid electrolyte falls within a range of from 0.80 g/cm³ to 1.20 g/cm³.

6. The method of producing a lithium ion secondary battery according to claim 1, wherein the charge and discharge treatment step includes performing discharge under conditions where a discharge end potential of the positive electrode is from 0.3 V(Li⁺/Li) to 1.8 V(Li⁺/Li), and performing charge under conditions where a charge end potential of the positive electrode is from 2.0 V(Li⁺/Li) to 4.3 V(Li⁺/Li).
